(19) United States
(12) Patent Application Publication
(10) Pub. No.: US 2019/0289274 A1
(43) Pub. Date: Sep. 19, 2019

(54) SYSTEMS AND METHODS FOR GENERATING A SOCIALLY BUILT VIEW OF VIDEO CONTENT

(71) Applicant: GOPRO, INC., San Mateo, CA (US)

(72) Inventors: Alexandre Jenny, Challes les eaux (FR); David Newman, San Diego, CA (US); Xavier Farret, San Mateo, CA (US); Samy Aboudrar, San Mateo, CA (US)

(21) Appl. No.: 15/285,088

(22) Filed: Oct. 4, 2016

Related U.S. Application Data
(60) Provisional application No. 62/371,154, filed on Aug. 4, 2016.

(51) Int. Cl. H04N 13/04; H04L 12/24; H04L 29/08

(52) U.S. Cl. CPC H04N 13/0445; H04N 13/0468; H04L 67/22; H04L 41/0893

(57) ABSTRACT

Interaction information may be received. The interaction information may indicate users' spatial selections of the video content as a function of progress through the video content. The video content may have a progress length. The spatial selections of the video content may include viewing directions of the video content selected by the users as the function of progress through the video content. Aggregate spatial selections of the video content may be determined at individual points in the progress length. Aggregate spatial selections may include an aggregation of the viewing directions selected by the users at the individual points. Directions of view for the video content may be determined based on the aggregate spatial selections of the video content. The socially built view of video content may be generated based on the directions of view for the video content.

### FIELD

This disclosure relates to generating a socially built view of video content.

### BACKGROUND

For video content including a greater content field of view than can normally be viewed within a single viewpoint, it may be difficult and time consuming to manually set viewpoints for playback. For example, the direction of a thing/event of interest captured within spherical video content may change during playback (due to movement of the thing/event and/or movement of the viewpoint, etc.). It may be difficult to manually set viewpoints for the video content to follow the thing/event of interest during playback. Additionally, different groups of people may find different things/events interesting within video content.

### SUMMARY

This disclosure relates to generating a socially built view of video content. Interaction information may be received. The interaction information may indicate users' spatial selections of the video content as a function of progress through the video content. The video content may have a progress length. The spatial selections of the video content may include viewing directions of the video content selected by the users as the function of progress through the video content. Aggregate spatial selections of the video content may be determined at individual points in the progress length. Aggregate spatial selections may include an aggregation of the viewing directions selected by the users at the individual points. Directions of view for the video content may be determined based on the aggregate spatial selections of the video content. The socially built view of video content may be generated based on the directions of view for the video content. For example, and without limitation, at some or all points throughout the video content, the aggregate spatial selections may include the most popular views, the most viewed content, and/or other aggregations of the previous spatial selections made by users.

A system for generating a socially built view of video content may include one or more physical processors, and/or other components. The physical processor(s) may be configured by machine-readable instructions. Executing the machine-readable instructions may cause the physical processor(s) to facilitate generating a socially built view of video content. The machine-readable instructions may include one or more computer program components. The computer program components may include one or more of a receive component, an aggregate component, a direction of view component, a socially built view component, and/or other computer program components. In some implementations, the computer program components may include an extent of view component and/or other components.

The receive component may be configured to receive interaction information. The interaction information may indicate one or more users' spatial selections of the video content as a function of progress through the video content. Video content may refer to media content that may be consumed as one or more videos. Video content may include one or more videos stored in one or more formats/container, and/or other video content. The video content may have a progress length. In some implementations, the video content may include one or more of spherical video content, virtual reality content, and/or other video content. In some implementations, the spatial selections of the video content may be determined based on one or more of the users' viewing, tagging, sharing, and/or extraction of one or more portions of the video content, and/or other information.

The spatial selections of the video content may include one or more viewing directions of the video content selected by the users as the function of progress through the video content. In some implementations, the viewing directions of the video content selected by the users may be characterized by a yaw parameter, a pitch parameter, and/or other parameters. In some implementations, the viewing directions of the video content selected by the users may be further characterized by a roll parameter, and/or other parameters. In some implementations, the spatial selections of the video content may include one or more viewing extents of the video content selected by the users as the function of progress through the video content.

The aggregate component may be configured to determine aggregate spatial selections of the video content at individual points in the progress length. Individual points in the progress length may include a first point in the progress length and/or other points in the progress length. The aggregate spatial selection of the video content at the first point in the progress length may include an aggregation of the viewing directions of the video content selected by the users at the first point in the progress length. In some implementations, the aggregate spatial selection of the video content at the first point in the progress length may include an aggregation of the viewing extents of the video content selected by the users at the first point in the progress length.

The direction of view component may be configured to determine one or more directions of view for the video content as the function of progress through the video content. One or more directions of view for the video content may be determined based on the aggregate spatial selections of the video content and/or other information. One or more directions of view may include one or more of the viewing directions of the video content most selected by the users as the function of progress through the video content. One or more directions of view may include a first direction of view at the first point in the progress length. The first direction of view may include one of the viewing directions of the video content most selected by the users at the first point in the progress length.

In some implementations, the extent of view component may be configured to determine one or more extents of view for the video content as the function of progress through the video content. One or more extents of view for the video content may be determined based on the aggregate spatial selections of the video content and/or other information. One or more extents of view may include one or more of the viewing extents of the video content most selected by the users as the function of progress through the video content. One or more extents of view may include a first extent of view at the first point in the progress length. The first extent of view may include one of the viewing extents of the video content most selected by the users at the first point in the progress length.

The socially built view component may be configured to generate one or more socially built view of the video content based on one or more directions of view for the video content and/or other information. A socially built view of the video content may include one or more of the viewing directions of the video content most selected by the users as the function of progress through the video content. In some implementations, the socially built view component may generate the socially built view of the video content further based on one or more extents of view for the video content and/or other information. The socially built view of the video content may include one or more of the viewing extents of the video content most selected by the users as the function of progress through the video content. In some implementations, the socially built view of the video content may be characterized by a projection parameter.

In some implementations, the users may be associated with one or more groups. The users in a group may be characterized by one or more common characteristics. Common characteristics may include one or more of a common gender, a common age group, a common location, a common interest, and/or other common characteristics. The socially built view of the video content may be associated with the group.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for generating a socially built view of video content.

FIG. 2 illustrates a method for generating a socially built view of video content.

FIG. 3 illustrates examples of rotational axes for video content.

FIGS. 4A-4B illustrate examples of field of view extents for video content.

FIG. 5A illustrates an example of aggregate spatial selections of video content.

FIG. 5B illustrates an example of aggregate spatial selections of video content shown in an equirectangular view.

FIG. 6A illustrates an example of a direction of view for video content.

FIG. 6B illustrates an examples of an extent of view for video content.

### DETAILED DESCRIPTION

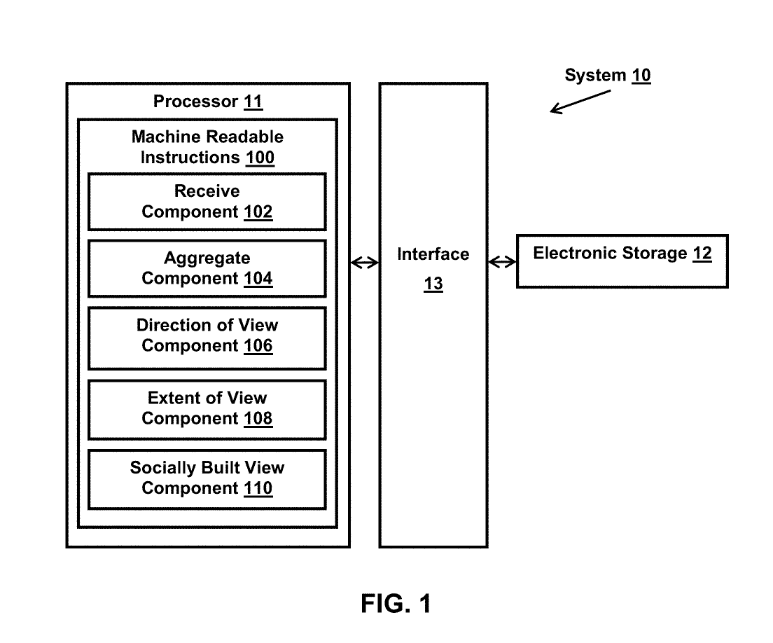

FIG. 1 illustrates system 10 for generating a socially built view of video content. System 10 may include one or more of processor 11, electronic storage 12, interface 13 (e.g., bus, wireless interface, etc.), and/or other components. Interaction information may be received by processor 11. The interaction information may indicate users' spatial selections of the video content as a function of progress through the video content. The video content may have a progress length. The spatial selections of the video content may include viewing directions of the video content selected by the users as the function of progress through the video content. Aggregate spatial selections of the video content may be determined at individual points in the progress length. Aggregate spatial selections may include an aggregation of the viewing directions selected by the users at the individual points. Directions of view for the video content may be determined based on the aggregate spatial selections of the video content. The socially built view of video content may be generated based on the directions of view for the video content. For example, and without limitation, at some or all points throughout the video content, the aggregate spatial selections may include the most popular views, the most viewed content, and/or other aggregations of the previous spatial selections made by users.

Electronic storage 12 may include electronic storage medium that electronically stores information. Electronic storage 12 may store software algorithms, information determined by processor 11, information received remotely, and/or other information that enables system 10 to function properly. For example, electronic storage 12 may store information relating to video content, interaction information, spatial selections of the video content, viewing directions of the video content selected by the users, aggregate spatial selections, socially built view of the video content, and/or other information.

Processor 11 may be configured to provide information processing capabilities in system 10. As such, processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. Processor 11 may be configured to execute one or more machine-readable instructions 100 to facilitate generating a socially built view of video content. Machine-readable instructions 100 may include one or more computer program components. Machine-readable instructions 100 may include one or more of receive component 102, aggregate component 104, direction of view component 106, socially built view component 110, and/or other computer program components. In some implementations, machine-readable instructions 100 may include extent of view component 108.

Receive component 102 may be configured to receive interaction information for one or more video content. Interaction information may indicate how one or more users interacted with the video content(s). The interaction information may indicate one or more users' spatial selections of the video content as a function of progress through the video content. The interaction information may be received at once (e.g., interaction information for one or more users may be received after the user(s) have finished interacting with the video content) or over a period of time (e.g., interaction information for one or more users may be received as the user(s) interact with the video content). Receive component 102 may continually/periodically monitor one or more users' interactions with the video content to receive the interaction information and/or may receive the interaction information in response to a user/system prompt.

Video content may refer to media content that may be consumed as one or more videos. Video content may include one or more videos stored in one or more formats/container, and/or other video content. A video may include a video clip captured by a video capture device, multiple video clips captured by a video capture device, and/or multiple video clips captured by separate video capture devices. A video may include multiple video clips captured at the same time and/or multiple video clips captured at different times. A video may include a video clip processed by a video application, multiple video clips processed by a video application and/or multiple video clips processed by separate video applications.

The video content may have a progress length. A progress length may be defined in terms of time durations and/or frame numbers. For example, video content may include a video having a time duration of 60 seconds. Video content may include a video having 1800 video frames. Video content having 1800 video frames may have a play time duration of 60 seconds when viewed at 30 frames/second. Other time durations and frame numbers are contemplated.

In some implementations, the video content may include one or more of spherical video content, virtual reality content, and/or other video content. Spherical video content may refer to a video capture of multiple views from a single location. Spherical video content may include a full spherical video capture (360 degrees of capture) or a partial spherical video capture (less than 360 degrees of capture). Spherical video content may be captured through the use of one or more cameras/image sensors to capture images/videos from a location. The captured images/videos may be stitched together to form the spherical video content.

Virtual reality content may refer to content that may be consumed via virtual reality experience. Virtual reality content may associate different directions within the virtual reality content with different viewing directions, and a user may view a particular direction within the virtual reality content by looking in a particular direction. For example, a user may use a virtual reality headset to change the user's direction of view. The user's direction of view may correspond to a particular direction of view within the virtual reality content. For example, a forward looking direction of view for a user may correspond to a forward direction of view within the virtual reality content.

Spherical video content and/or virtual reality content may have been captured at one or more locations. For example, spherical video content and/or virtual reality content may have been captured from a stationary position (e.g., a seat in a stadium). Spherical video content and/or virtual reality content may have been captured from a moving position (e.g., a moving bike). Spherical video content and/or virtual reality content may include video capture from a path taken by the capturing device(s) in the moving position. For example, spherical video content and/or virtual reality content may include video capture from a person walking around in a music festival.

Spatial selections of the video content may refer to the one or more portions of space within the video content with which the users interacted. Users' spatial selections of the video content may remain the same or change as a function of progress through the video content. For example, a user may view the video content without changing the direction of view (e.g., a user may view a “default view” of video content captured at a music festival, etc.). A user may view the video content by changing the directions of view (e.g., a user may change the direction of view of video content captured at a music festival to follow a particular band, etc.). Other types of spatial selections of the video content are contemplated.

The spatial selections of the video content may include one or more viewing directions of the video content selected by the users as the function of progress through the video content. Viewing directions of the video content may correspond to orientations of fields of view within which the users interacted with the video content. In some implementations, the viewing directions of the video content selected by the users may be characterized by a yaw parameter, a pitch parameter, and/or other parameters. In some implementations, the viewing directions of the video content selected by the users may be further characterized by a roll parameter, and/or other parameters. A yaw parameter may define an amount of yaw rotation for video content. A pitch parameter may define an amount of pitch rotation for video content. A roll parameter may define an amount of raw rotation for video content.

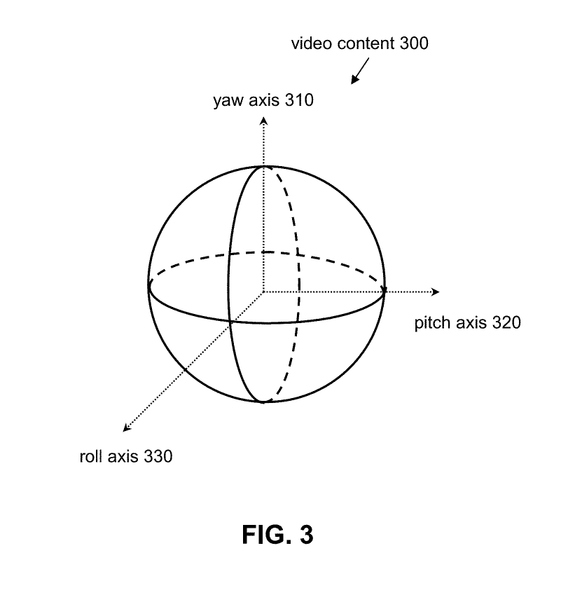

For example, FIG. 3 illustrates examples of rotational axes for video content 300. Rotational axes for video content 300 may include yaw axis 310, pitch axis 320, roll axis 330, and/or other axes. A yaw parameter may define an amount of rotation of video content 300 around yaw axis 310. For example, a 0-degree rotation of video content 300 around yaw axis 310 may correspond to a front viewing direction. A 90-degree rotation of video content 300 around yaw axis 310 may correspond to a right viewing direction. A 180-degree rotation of video content 300 around yaw axis 310 may correspond to a back viewing direction. A −90-degree rotation of video content 300 around yaw axis 310 may correspond to a left viewing direction.

A pitch parameter may define an amount of rotation of video content 300 around pitch axis 320. For example, a 0-degree rotation of video content 300 around pitch axis 320 may correspond to a viewing direction that is level with respect to horizon. A 45-degree rotation of video content 300 around pitch axis 320 may correspond to a viewing direction that is pitched up with respect to horizon by 45-degrees. A 90 degree rotation of video content 300 around pitch axis 320 may correspond to a viewing direction that is pitched up with respect to horizon by 90-degrees (looking up). A −45-degree rotation of video content 300 around pitch axis 320 may correspond to a viewing direction that is pitched down with respect to horizon by 45-degrees. A −90 degree rotation of video content 300 around pitch axis 320 may correspond to a viewing direction that is pitched down with respect to horizon by 90-degrees (looking down).

A roll parameter may define an amount of rotation of video content 300 around roll axis 330. For example, a 0-degree rotation of video content 300 around roll axis 330 may correspond to a viewing direction that is upright. A 90 degree rotation of video content 300 around roll axis 330 may correspond to a viewing direction that is rotated to the right by 90 degrees. A −90-degree rotation of video content 300 around roll axis 330 may correspond to a viewing direction that is rotated to the left by 90-degrees.

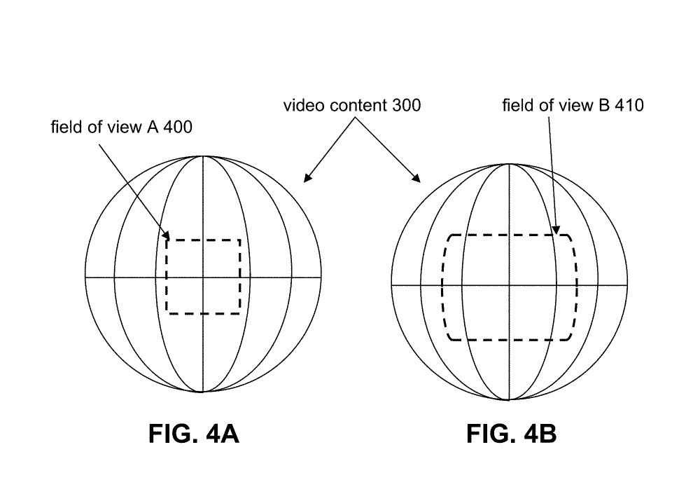

In some implementations, the spatial selections of the video content may include one or more viewing extents of the video content selected by the users as the function of progress through the video content. Viewing extents of the video content may correspond to sizes of the field of view (zoom) within which the users interacted with the video content. FIGS. 4A-4B illustrate examples of field of view extents for video content 300. In FIG. 4A, viewing extent of video content 300 may correspond to the size of field of view A 400. In FIG. 4B, viewing extent of video content 300 may correspond to the size of field of view B 410. Viewing extent of video content 300 in FIG. 4A may be smaller than viewing extent of video content 300 in FIG. 4B.

In some implementations, the spatial selections of the video content may be determined based on one or more of the users' viewing, tagging, sharing, and/or extraction of one or more portions of the video content, and/or other information. For example, users' spatial selections of the video content may be determined based on users' viewing of one or more portions of the video content via virtual reality headsets and/or other video players that allow the users to change the direction, rotation, and/or zoom of view. Users' directions, rotations, and zooms of viewing the video content may be tracked so that for different points of progress within the content, information indication the direction, rotation, and/or zoom of users' views may be stored.

Users' spatial selections of the video content may be determined based on users' tagging of one or more portions of the video content with one or more information. For example, users may tag one or more portions of the video content corresponding to a particular direction, rotation, and/or zoom as a highlight, with comments, and/or with other information.

User's spatial selections of the video content may be determined based on users' sharing of one or more portions of the video content. For example, users may share one or more portions of the video content corresponding to a particular direction, rotation, and/or zoom as a link, multiple links, an image, multiple images, a video clip, and/or multiple video clips.

Users' spatial selections of the video content may be determined based on users' extraction of one or more portions of the video content. For example, users may extract one or more portions of the video content corresponding to a particular direction, rotation, and/or zoom as an image, multiple images, a video clip, and/or multiple video clips. User's spatial selections of the video content determined based on users' other interactions with one or more portions of the video content are contemplated.

Aggregate component 104 may be configured to determine aggregate spatial selections of the video content at individual points in the progress length (e.g., at different playtime positions and/or frame positions). At individual points in the progress length, users' interactions with the video content may be tracked to determine users' aggregate viewing directions and/or viewing extents for the video content. Individual points in the progress length may include one or more points in the progress length. For example, video content having a time duration of 60 seconds and 1800 video frames may include a point at playtime position of 30 second/video frame position of 900.

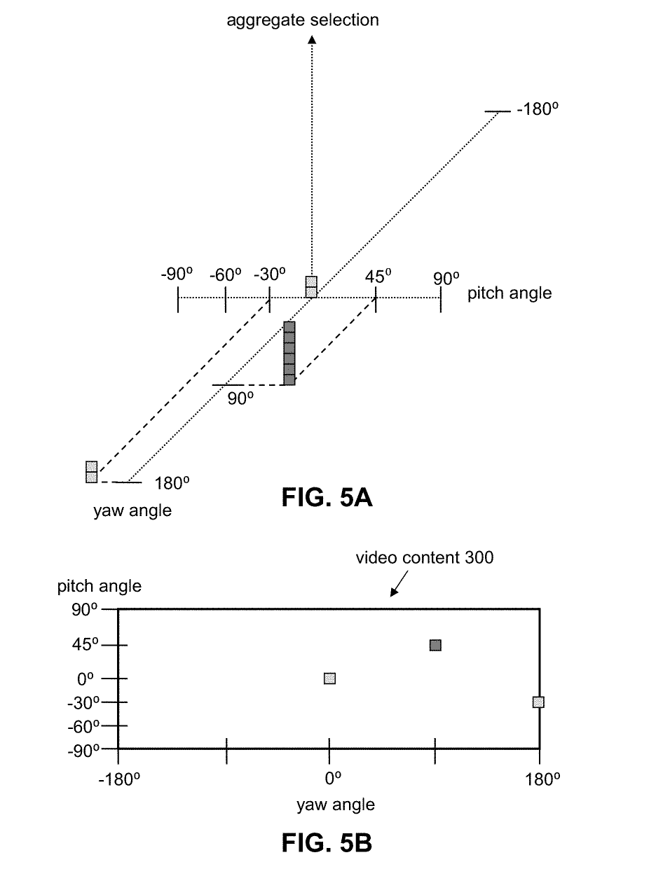

The aggregate spatial selections of the video content at an individual point in the progress length may include an aggregation of the viewing directions of the video content selected by the users at that point in the progress length. For example, FIG. 5A illustrates an example of aggregate spatial selections of video content at a particular point in the progress length. The aggregate spatial selection may include spatial selection of the video content by ten users. As shown in FIG. 5A, at the particular point in the progress length, two users may have selected a viewing direction of 0-degree yaw angle and 0-degree pitch angle. Two users may have selected a viewing direction of 180-degree yaw angle and −30-degree pitch angle. Six users may have selected a viewing direction of 90-degree yaw angle and 45-degree pitch angle.

FIG. 5B illustrates an example of aggregate spatial selections of video content shown in an equirectangular view. FIG. 5B may include a heat map representation of the aggregate spatial selections where the amounts of viewing directions in individual yaw angle and pitch angle are represented in different colors/shadings. For example, two lighter colored blocks in FIG. 5B may correspond to two users' selections of a viewing direction of 0-degree yaw angle and 0-degree pitch angle and two users' selections of a viewing direction of 180-degree yaw angle and −30-degree pitch angle. The darker colored block may correspond to six users' selections of a viewing direction of 90-degree yaw angle and 45-degree pitch angle. The heat map shown in FIG. 5B may represent different numbers of users selecting different viewing directions at the particular point in time.

In some implementations, the aggregate spatial selection of the video content at an individual point in the progress length may include an aggregation of the viewing extents of the video content selected by the users at that particular point in the progress length. The aggregate spatial selection of the video content at an individual point in the progress length may include information about different numbers of users selecting different viewing extent at the particular point in time.

Aggregating the spatial selections of the video content as a function of the progress length may allow aggregate component 104 to aggregate users' spatial selections of the video content that occurred at different times and/or at different speeds. For example, aggregate component 104 may determine aggregate spatial selections of video content having a time duration of 60 seconds and 1800 video frames. For the playtime position of 30 second/the video frame of 900, aggregate component 104 may aggregate users' spatial selections of the video content. The users' spatial selection of the video content may have occurred simultaneously (e.g., two users watched the video content starting at the same time and at the same play speed, etc.) or at different times (e.g., two users watched the video content at different times, etc.). The users' spatial selection of the video content may have occurred at the same speed (e.g., three users watched the video content at 1× speed, etc.) or at different speeds (e.g., a first user watched the video content at 1× speed, a second user watched the video content at 2× speed, and third user watched the video content at 1.5× reverse speed, etc.).

Direction of view component 106 may be configured to determine one or more directions of view for the video content as the function of progress through the video content. Directions of view for the video content may correspond to orientations of fields of view within which a socially built view of the video content may be viewed. Directions of view for the video content may be characterized by a yaw parameter, a pitch parameter, and/or other parameters. In some implementations, directions of view for the video content may be further characterized by a roll parameter and/or other parameters.

Direction of view component 106 may determine one or more directions of view for the video content based on the aggregate spatial selections of the video content and/or other information. For example, direction of view component 106 may determine one or more directions of view for video content at a particular point in the progress length based on the aggregated spatial selections of the video content shown in FIGS. 5A-5B. One or more directions of view may include one or more of the viewing directions of the video content most selected by the users as the function of progress through the video content. The determination of directions of view based on the viewing directions most selected by the users may allow the socially built view of the video content to follow the viewing directions most selected by the users.

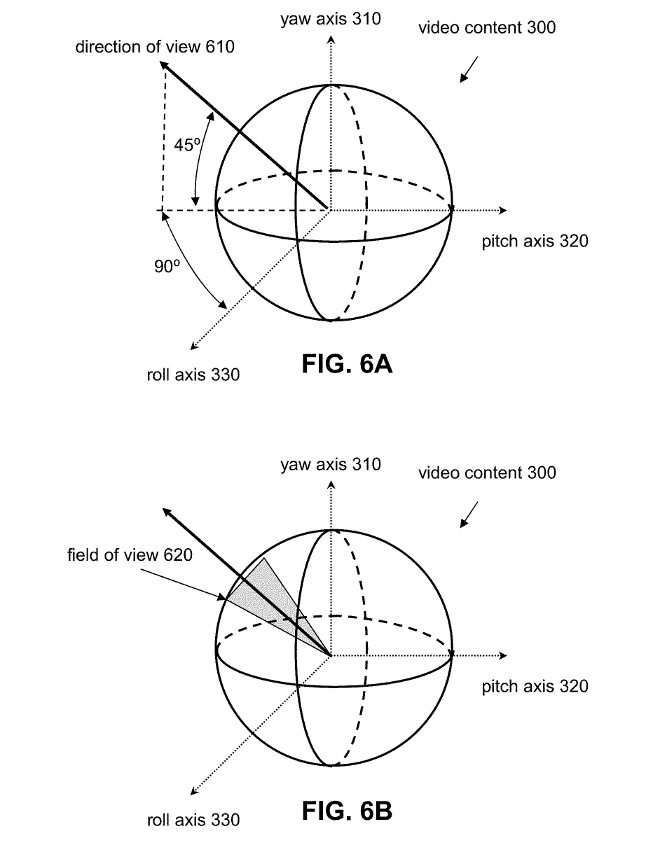

One or more directions of view may include particular directions of view at particular points in the progress length. At individual points in the progress length, directions of view for the video content may define orientations of fields of view within which a socially built view of the video content may be viewed. For example, at a particular point in the progress length, one or more directions of view for the video content may include direction of view 610 as shown in FIG. 6A. Direction of view 610 may be characterized by a 90-degree yaw angle, 45-degree pitch angle, and/or other angles. Direction of view 610 may correspond to a direction most selected by the users at the particular point in the progress length.

In some implementations, a particular point in the progress length may include multiple viewing directions most selected by the users (e.g., two users selected a front viewing directions while two other users selected a left viewing direction, etc.). In some implementations, different spatial selections of the video content may be weighed differently. For example, one or more spatial selections of the video content based on one or more types of user interactions may be weighed the same, more, or less than one or more spatial selections of the video content based on other types of user interactions. For example, spatial selections of the video content based on users' viewing of the video content may be weighed less than spatial selections of the video content based on users' tagging, sharing, and/or extraction of the video content. Other types of weighing of spatial selections are contemplated.

Different weighing of spatial selections of the video content may allow for distinction between spatial selections of the video content that may otherwise be equal in amounts of interaction. For example, at a particular point in progress length, two users may have viewed a certain portion of the video content. At the particular point in progress length, two other users may have shared another portion of the video content. In some implementations, direction of view component 106 may select the viewing direction associated with the sharing of the video content over the viewing direction associated with the viewing of the video content based on the weighing of the spatial selections.

In some implementations, extent of view component 108 may be configured to determine one or more extents of view for the video content as the function of progress through the video content. Extents of view for the video content may correspond to sizes of fields of view within which a socially built view of the video content may be viewed. Extents of view for the video content may be characterized by one or more angles (e.g., horizontal angle, vertical angle, diagonal angle, etc.).

One or more extents of view for the video content may be determined based on the aggregate spatial selections of the video content and/or other information. One or more extents of view may include one or more of the viewing extents of the video content most selected by the users as the function of progress through the video content. The determination of extents of view based on the viewing extents most selected by the users may allow the socially built view of the video content to include the viewing extents (e.g., zoom, etc.) most selected by the users.

One or more extents of view may include particular extents of view at the particular points in the progress length. At individual points in the progress length, extents of view for the video content may define size/zoom of field of view within which a socially built view of the video content may be viewed. For example, at a particular point in the progress length, one or more extents of view for the video content may include field of view 620 shown in FIG. 6B. Field of view 620 may be characterized by direction of view 610 (shown in FIG. 6A) and size/zoom illustrated via shaded area in FIG. 6B. Extent of view for field of view 620 may correspond to an extent most selected by the users at the particular point in the progress length.

In some implementations, a particular point in the progress length may include multiple viewing extents most selected by the users (e.g., two users selected a small viewing extent for a viewing direction while two other users selected a large viewing extent for the viewing direction, etc.). In some implementations, different spatial selections of the video content corresponding to different viewing extents may be weighed differently.

Socially built view component 110 may be configured to generate one or more socially built views of the video content based on one or more directions of view for the video content and/or other information. A socially built view of the video content may provide one or more directions of view within which the video content may be viewed. At individual points in the progress length, a socially built view of the video content may include one or more of the viewing directions of the video content most selected by the users. A socially built view of the video content may provide for directions of view within which spherical and/or virtual reality content may be viewed to include the viewing directions most selected by the users.

In some implementations, socially built view component 110 may generate one or more socially built views of the video content further based on one or more extents of view for the video content and/or other information. A socially built view of the video content may provide one or more extents of view within which the video content may be viewed. At individual points in the progress length, a socially built view of the video content may include one or more of the viewing extents of the video content most selected by the users. A socially built view of the video content may provide for extents of view within which spherical and/or virtual reality content may be viewed to include the viewing extents most selected by the users.

In some implementations, socially built view component 110 may generate one or more socially built views of the video content based on multiple directions of view and/or multiple extents of view at particular points in the progress length. At such points in the progress length, the socially built view of the video content may include: (1) a direction/extent of view chosen randomly from the multiple directions/extents of view; (2) a direction/extent of view chosen from the multiple directions/extents of view by a user; (3) a direction/extent of view chosen from the multiple directions/extents of view based on weighing of the spatial selections of the video content; and/or (4) multiple directions/extents. Multiple directions and/or extents of view in a socially built view of the video content may allow a user to choose a particular direction and/or extent while viewing the socially built view of the video content (e.g., based on user preference and/or user choice during viewing, etc.) and/or view multiple directions/extents while viewing the socially built view of the video content (e.g., via multiple screens, split screens, etc.).

In some implementations, the socially built view of the video content may be characterized by a projection parameter. For example, one or more portions of the socially built view of the video content may be characterized by one or more of a stereographic projection, little planet projection, tunnel view projection, equirectangular projection, rectilinear projection, and/or other projections. One or more projection parameters for the socially built view of the video content may be determined based on the users' spatial selections of the video content and/or manually selected by users. For example, a user may share a highlight point in video content via sharing the socially built view of the video content (including direction of view and extent of view) characterized by a particular type of projection.

A socially built view of video content may be encoded into the video content and/or stored separately. A socially built view of video content may allow users to deviate from one or more viewing characteristics as defined by direction of view, extent of view, projection parameter, and/or viewing characteristics. For example, a socially built view of the video content may include particular directions of view that may be viewed as a “default” view of the video content. Users viewing the socially built view may deviate from the “default” view. For example, a user may deviate from a front viewing direction by manually adjusting the direction of view while watching the video content. In some implementations, when a user stops manually adjusting the direction of view, the direction of view may return to the “default” view.

In some implementations, a socially built view of the video content may change based on changes in aggregate spatial selections of the video content. For example, socially built view component 110 may generate a socially built view of the video content based on aggregate spatial selection of the video content by ten users. After the generation of the socially built view of the video content, aggregate component 104 may determine updated aggregate spatial selections of the video content based on additional user interactions (e.g., one or more of the ten users interacted with video content again and/or one or more new users interacted with the video content, etc.). Socially built view component 110 may generate an updated socially built view of the video content based on the updated aggregate spatial selection of the video content. The updated socially built view of the video content may be created as new file(s) and/or overwrite prior version of the socially built view.

In some implementations, the users may be associated with one or more groups. A group may refer to a collection of users who share one or more commonalities. One or more commonalities may be a temporary characteristic of the users or a permanent characteristic of the users. The users in the group may be characterized by one or more common characteristics. A common characteristic may refer to a feature and/or a quality shared by the users in a group. Common characteristics may include one or more of a common gender, a common age group, a common location, a common interest, and/or other common characteristics. The socially built view of the video content may be associated with the group with which the users are associated. Socially built view of the video content may be provided to users based on the group with which the socially built view is associated.

Association of the users and the socially built views of the video content may allow for creation and/or sharing of different socially built views for different groups. For example, socially built views of video content may be generated based on spatial selections of the video content by users in different age groups. Age groups may be separate by different ages/age ranges of the users. For example, different socially built views of the video content may be generated for age groups of toddler, children, young adults, adults, seniors, and/or other age groups. Users in different groups may be provided with (e.g., via suggested view links, etc.) socially built views associated with the particular group. Associating the socially built views with one or more groups may allow users to search for and/or consume socially built views associated with different/particular groups.

While the present disclosure may be directed to video content, one or more other implementations of the system may be configured for other types media content. Other types of media content may include one or more of audio content (e.g., music, podcasts, audio books, and/or other audio content), multimedia presentations, photos, slideshows, and/or other media content.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although processor 11 and electronic storage 12 are shown to be connected to an interface 13 in FIG. 1, any communication medium may be used to facilitate interaction between any components of system 10. One or more components of system 10 may communicate with each other through hard-wired communication, wireless communication, or both. For example, one or more components of system 10 may communicate with each other through a network. For example, processor 11 may wirelessly communicate with electronic storage 12. By way of non-limiting example, wireless communication may include one or more of radio communication, Bluetooth communication, Wi-Fi communication, cellular communication, infrared communication, or other wireless communication. Other types of communications are contemplated by the present disclosure.

Although processor 11 is shown in FIG. 1 as a single entity, this is for illustrative purposes only. In some implementations, processor 11 may comprise a plurality of processing units. These processing units may be physically located within the same device, or processor 11 may represent processing functionality of a plurality of devices operating in coordination. Processor 11 may be configured to execute one or more components by software; hardware; firmware; some combination of software, hardware, and/or firmware; and/or other mechanisms for configuring processing capabilities on processor 11.

It should be appreciated that although computer components 102, 104, 106, 108, and 110 are illustrated in FIG. 1 as being co-located within a single processing unit, in implementations in which processor 11 comprises multiple processing units, one or more of computer program components 102, 104, 106, 108, and/or 110 may be located remotely from the other computer program components.

The description of the functionality provided by the different computer program components described herein is for illustrative purposes, and is not intended to be limiting, as any of computer program components may provide more or less functionality than is described. For example, one or more of computer program components 102, 104, 106, 108, and/or 110 may be eliminated, and some or all of its functionality may be provided by other computer program components. As another example, processor 11 may be configured to execute one or more additional computer program components that may perform some or all of the functionality attributed to one or more of computer program components 102, 104, 106, 108, and/or 110 described herein.

The electronic storage media of electronic storage 12 may be provided integrally (i.e., substantially non-removable) with one or more components of system 10 and/or removable storage that is connectable to one or more components of system 10 via, for example, a port (e.g., a USB port, a Firewire port, etc.) or a drive (e.g., a disk drive, etc.). Electronic storage 12 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. Electronic storage 12 may be a separate component within system 10, or electronic storage 12 may be provided integrally with one or more other components of system 10 (e.g., processor 11). Although electronic storage 12 is shown in FIG. 1 as a single entity, this is for illustrative purposes only. In some implementations, electronic storage 12 may comprise a plurality of storage units. These storage units may be physically located within the same device, or electronic storage 12 may represent storage functionality of a plurality of devices operating in coordination.

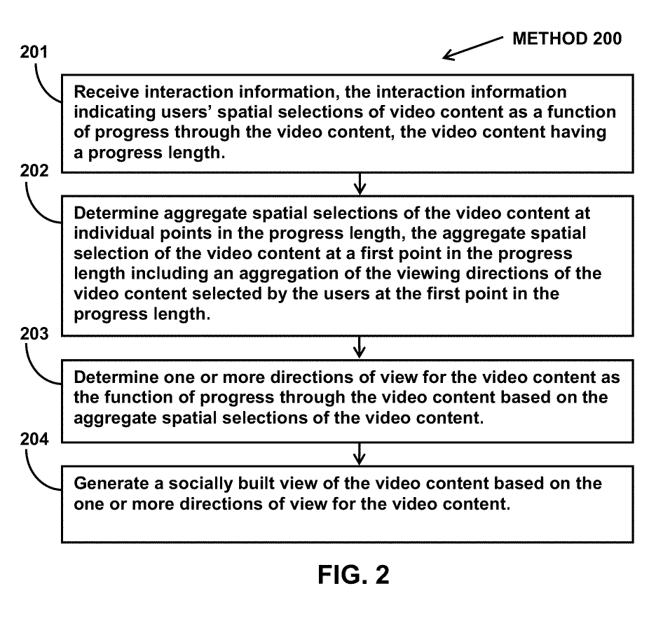

FIG. 2 illustrates method 200 for generating a socially built view of video content. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage mediums. The one or more processing devices may include one or more devices configured through hardware, firmware, and/or software to be specifically designed for execution of one or more of the operations of method 200.

Referring to FIG. 2 and method 200, at operation 201, interaction information may be received. Interaction information may indicate users' spatial selections of video content as a function of progress through the video content. The video content may have a progress length. The spatial selections of the video content may include viewing directions of the video content selected by the users as the function of progress through the video content. In some implementations, operation 201 may be performed by a processor component the same as or similar to receive component 102 (shown in FIG. 1 and described herein).

At operation 202, aggregate spatial selections of the video content at individual points in the progress length may be determined. Individual points in the progress length may include a first point in the progress length. The aggregate spatial selection of the video content at the first point in the progress length may include an aggregation of the viewing directions of the video content selected by the users at the first point in the progress length. In some implementations, operation 202 may be performed by a processor component the same as or similar to aggregate component 104 (shown in FIG. 1 and described herein).

At operation 203, one or more directions of view for the video content as the function of progress through the video content may be determined. One or more directions of view may be determined based on the aggregate spatial selections of the video content. One or more directions of view may include one or more of the viewing directions of the video content most selected by the users as the function of progress through the video content. One or more directions of view may include a first direction of view at the first point in the progress length. The first direction of view may include one of the viewing directions of the video content most selected by the users at the first point in the progress length. In some implementations, operation 203 may be performed by a processor component the same as or similar to direction of view component 106 (shown in FIG. 1 and described herein).

At operation 204, the socially built view of the video content may be generated. The socially built view of the video content may be generated based on the one or more directions of view for the video content. The socially built view of the video content may include one or more of the viewing directions of the video content most selected by the users as the function of progress through the video content. In some implementations, operation 204 may be performed by a processor component the same as or similar to socially built view component 110 (shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementations.

1. A system for generating a socially built view of spherical video content, the system comprising:
one or more physical processors configured by machine-readable instructions to:
receive interaction information indicating users' spatial selections of the spherical video content as a function of progress through the spherical video content, the spherical video content having a progress length and the spatial selections of the spherical video content including viewing directions of the spherical video content selected by the users as the function of progress through the spherical video content, the viewing directions corresponding to orientations of fields of view within which the users interacted with the spherical video content;
determine aggregate spatial selections of the spherical video content at individual points in the progress length, the individual points in the progress length including a first point in the progress length, wherein the aggregate spatial selection of the spherical video content at the first point in the progress length includes an aggregation of the viewing directions of the spherical video content selected by the users at the first point in the progress length, the aggregation of the viewing directions of the spherical video content selected by the users at the first point in the progress length corresponding to an aggregation of the orientations of the fields of view within which the users interacted with the spherical video content at the first point in the progress length;
determine one or more directions of view for the spherical video content as the function of progress through the spherical video content based on the aggregate spatial selections of the spherical video content, the one or more directions of view including one or more of the viewing directions of the spherical video content most selected by the users as the function of progress through the spherical video content such that the one or more directions of view include a first direction of view at the first point in the progress length, the first direction of view including one of the viewing directions of the spherical video content most selected by the users at the first point in the progress length; and
generate the socially built view of the spherical video content based on the one or more directions of view for the spherical video content, the socially built view of the spherical video content including the one or more of the viewing directions of the spherical video content most selected by the users as the function of progress through the spherical video content;
wherein:
a playback of the spherical video content based on the socially built view includes presentation of the one or more directions of view for the spherical video content as a default view;
responsive to a user's manual adjustment of a direction of view during the playback, the playback of the spherical video content deviates from the default view; and
responsive to the user's stopping of the manual adjustment, the playback of the spherical video content returns to the default view.

2. The system of claim 1, wherein:
the spatial selections of the spherical video content include viewing extents of the spherical video content selected by the users as the function of progress through the spherical video content;
the aggregate spatial selection of the spherical video content at the first point in the progress length further includes an aggregation of the viewing extents of the spherical video content selected by the users at the first point in the progress length; and
the one or more physical processors are further configured by machine-readable instructions to:
determine one or more extents of view for the spherical video content as the function of progress through the spherical video content based on the aggregate spatial selections of the spherical video content, the one or more extents of view including one or more of the viewing extents of the spherical video content most selected by the users as the function of progress through the spherical video content such that the one or more extents of view include a first extent of view at the first point in the progress length, the first extent of view including one of the viewing extents of the spherical video content most selected by the users at the first point in the progress length; and
generate the socially built view of the spherical video content further based on the one or more extents of view for the spherical video content, the socially built view of the spherical video content including the one or more of the viewing extents of the spherical video content most selected by the users as the function of progress through the spherical video content.

3. The system of claim 1, wherein the viewing directions of the spherical video content selected by the users are characterized by a yaw parameter and a pitch parameter.

4. The system of claim 3, wherein the viewing directions of the spherical video content selected by the users are further characterized by a roll parameter.

5. The system of claim 1, wherein the socially built view of the spherical video content is characterized by a projection parameter.

6. The system of claim 1, wherein the spatial selections of the spherical video content is determined based on one or more of the users' viewing, tagging, and/or sharing, one or more portions of the spherical video content.

7. The system of claim 1, wherein the spherical video content includes virtual reality content.

8. The system of claim 1, wherein the users are associated with a group and the socially built view of the spherical video content is associated with the group.

9. The system of claim 8, wherein the users in the group is characterized by one or more common characteristics.

10. A method for generating a socially built view of spherical video content, the method comprising:
receiving interaction information indicating users' spatial selections of the spherical video content as a function of progress through the spherical video content, the spherical video content having a progress length and the spatial selections of the spherical video content including viewing directions of the spherical video content selected by the users as the function of progress through the spherical video content, the viewing directions corresponding to orientations of fields of view within which the users interacted with the spherical video content;
determining aggregate spatial selections of the spherical video content at individual points in the progress length, the individual points in the progress length including a first point in the progress length, wherein the aggregate spatial selection of the spherical video content at the first point in the progress length includes an aggregation of the viewing directions of the spherical video content selected by the users at the first point in the progress length, the aggregation of the viewing directions of the spherical video content selected by the users at the first point in the progress length corresponding to an aggregation of the orientations of the fields of view within which the users interacted with the spherical video content at the first point in the progress length;
determining one or more directions of view for the spherical video content as the function of progress through the spherical video content based on the aggregate spatial selections of the spherical video content, the one or more directions of view including one or more of the viewing directions of the spherical video content most selected by the users as the function of progress through the spherical video content such that the one or more directions of view include a first direction of view at the first point in the progress length, the first direction of view including one of the viewing directions of the spherical video content most selected by the users at the first point in the progress length; and
generating the socially built view of the spherical video content based on the one or more directions of view for the spherical video content, the socially built view of the spherical video content including the one or more of the viewing directions of the spherical video content most selected by the users as the function of progress through the spherical video content;
wherein:
a playback of the spherical video content based on the socially built view includes presentation of the one or more directions of view for the spherical video content as a default view;
responsive to a user's manual adjustment of a direction of view during the playback, the playback of the spherical video content deviates from the default view; and
responsive to the user's stopping of the manual adjustment, the playback of the spherical video content returns to the default view.

11. The method of claim 10, wherein:
the spatial selections of the spherical video content include viewing extents of the spherical video content selected by the users as the function of progress through the spherical video content;
the aggregate spatial selection of the spherical video content at the first point in the progress length further includes an aggregation of the viewing extents of the spherical video content selected by the users at the first point in the progress length; and
the method further comprising:
determining one or more extents of view for the spherical video content as the function of progress through the spherical video content based on the aggregate spatial selections of the spherical video content, the one or more extents of view including one or more of the viewing extents of the spherical video content most selected by the users as the function of progress through the spherical video content such that the one or more extents of view include a first extent of view at the first point in the progress length, the first extent of view including one of the viewing extents of the spherical video content most selected by the users at the first point in the progress length; and
generating the socially built view of the spherical video content further based on the one or more extents of view for the spherical video content, the socially built view of the spherical video content including the one or more of the viewing extents of the spherical video content most selected by the users as the function of progress through the spherical video content.

12. The method of claim 10, wherein the viewing directions of the spherical video content selected by the users are characterized by a yaw parameter and a pitch parameter.

13. The method of claim 12, wherein the viewing directions of the spherical video content selected by the users are further characterized by a roll parameter.

14. The method of claim 10, wherein the socially built view of the spherical video content is characterized by a projection parameter.

15. The method of claim 10, wherein the spatial selections of the spherical video content is determined based on one or more of the users' viewing, tagging, and/or sharing one or more portions of the spherical video content.

16. The method of claim 10, wherein the spherical video content includes virtual reality content.

17. The method of claim 10, wherein the users are associated with a group and the socially built view of the spherical video content is associated with the group.

18. The method of claim 17, wherein the users in the group is characterized by one or more common characteristics.

19. A system for generating a socially built view of spherical video content, the system comprising:
one or more physical processors configured by machine-readable instructions to:
receive interaction information indicating users' spatial selections of the spherical video content as a function of progress through the spherical video content, the spherical video content having a progress length and the spatial selections of the spherical video content including viewing directions of the spherical video content selected by the users as the function of progress through the spherical video content, the viewing directions of the spherical video content selected by the users characterized by a yaw parameter and a pitch parameter and the users associated with a group, the viewing directions corresponding to orientations of fields of view within which the users interacted with the spherical video content, wherein the spatial selections of the spherical video content is determined based on one or more of the users' viewing, tagging, and/or sharing one or more portions of the spherical video content;
determine aggregate spatial selections of the spherical video content at individual points in the progress length, the individual points in the progress length including a first point in the progress length, wherein the aggregate spatial selection of the spherical video content at the first point in the progress length includes an aggregation of the viewing directions of the spherical video content selected by the users at the first point in the progress length, the aggregation of the viewing directions of the spherical video content selected by the users at the first point in the progress length corresponding to an aggregation of the orientations of the fields of view within which the users interacted with the spherical video content at the first point in the progress length;
determine one or more directions of view for the spherical video content as the function of progress through the spherical video content based on the aggregate spatial selections of the spherical video content, the one or more directions of view including one or more of the viewing directions of the spherical video content most selected by the users as the function of progress through the spherical video content such that the one or more directions of view include a first direction of view at the first point in the progress length, the first direction of view including one of the viewing directions of the spherical video content most selected by the users at the first point in the progress length; and
generate the socially built view of the spherical video content based on the one or more directions of view for the spherical video content, the socially built view of the spherical video content including the one or more of the viewing directions of the spherical video content most selected by the users as the function of progress through the spherical video content, the socially built view of the spherical video content associated with the group;
wherein:
a playback of the spherical video content based on the socially built view includes presentation of the one or more directions of view for the spherical video content as a default view;
responsive to a user's manual adjustment of a direction of view during the playback, the playback of the spherical video content deviates from the default view; and
responsive to the user's stopping of the manual adjustment, the playback of the spherical video content returns to the default view.

20. The system of claim 19, wherein:
the spatial selections of the spherical video content include viewing extents of the spherical video content selected by the users as the function of progress through the spherical video content;
the aggregate spatial selection of the spherical video content at the first point in the progress length further includes an aggregation of the viewing extents of the spherical video content selected by the users at the first point in the progress length; and
the one or more physical processors are further configured by machine-readable instructions to:
determine one or more extents of view for the spherical video content as the function of progress through the spherical video content based on the aggregate spatial selections of the spherical video content, the one or more extents of view including one or more of the viewing extents of the spherical video content most selected by the users as the function of progress through the spherical video content such that the one or more extents of view include a first extent of view at the first point in the progress length, the first extent of view including one of the viewing extents of the spherical video content most selected by the users at the first point in the progress length; and
generate the socially built view of the spherical video content further based on the one or more extents of view for the spherical video content, the socially built view of the spherical video content including the one or more of the viewing extents of the spherical video content most selected by the users as the function of progress through the spherical video content.
